(19) United States
(12) Patent Application Publication
(10) Pub. No.: US 2023/0420181 A1
(43) Pub. Date: Dec. 28, 2023

(54) TRANSFORMER AND ASSEMBLY METHOD THEREOF

(71) Applicant: LITE-ON SINGAPORE PTE. LTD., Singapore (SG)

(72) Inventors: Prasanth THUMMALA, Singapore (SG); Chun-Hwa SEE, Singapore (SG)

(21) Appl. No.: 17/849,420

(22) Filed: Jun. 24, 2022

(51) Int. Cl. H01F 27/32; H01F 27/24; H01F 27/29; H01F 41/076

(52) U.S. Cl. CPC H01F 27/325; H01F 41/076; H01F 27/29; H01F 27/24

(57) ABSTRACT

A transformer and an assembly method thereof are provided. The transformer includes a hollow bobbin, two magnetic cores, a primary winding, a plurality of first secondary windings and a plurality of second secondary windings. The two magnetic cores are inserted into the hollow bobbin. The primary winding is wound around the hollow bobbin. The first secondary windings and the second secondary windings surround the primary winding. The first secondary windings and the second secondary windings are alternately arranged around the primary winding.

### TECHNICAL FIELD

The disclosure relates in general to an electronic component and an assembly method thereof, and more particularly to a transformer and an assembly method thereof.

### BACKGROUND

With the development of science and technology, various kinds of electronic devices are constantly innovating. In some electronic devices, a transformer with high output current (>250 A) is needed. The main purpose of the transformer is to decrease or increase the voltage of the alternating current, change the impedance and separate the circuit. For a better performance, the researchers are working on decreasing the AC to DC resistance ratio of the transformer, and preventing electromagnetic interference (EMI) by balancing the primary-to-secondary interwinding capacitance and the leakage inductance of the transformer.

### SUMMARY

The disclosure is directed to a transformer and an assembly method thereof. A plurality of first secondary windings and a plurality of second secondary windings surround a primary winding. The first secondary windings and the second secondary windings are alternately arranged around the primary winding. As such, the AC to DC resistance ratio of the transformer can be decreased, the leakage inductance of the transformer can be increased, the power loss of the transformer can be reduced, and the primary-to-secondary interwinding capacitance of the transformer can be reduced, such that EMI is avoided.

According to an embodiment, a transformer is provided. The transformer includes a hollow bobbin, two magnetic cores, a primary winding, a plurality of first secondary windings and a plurality of second secondary windings. The two magnetic cores are inserted into the hollow bobbin. The primary winding is wound around the hollow bobbin. The first secondary windings and the second secondary windings surround the primary winding. The first secondary windings and the second secondary windings are alternately arranged around the primary winding.

According to another embodiment, a transformer includes a hollow bobbin, two magnetic cores, a primary winding, a plurality of first secondary windings and a plurality of second secondary windings. The two magnetic cores are inserted into the hollow bobbin. The primary winding is wound around the hollow bobbin. The first secondary windings and the second secondary windings surround the primary winding. An air gap is formed between the two magnetic cores.

According to another embodiment, an assembly method of a transformer includes the following steps. A primary winding is wrapped around a hollow bobbin. A plurality of first secondary windings and a plurality of second secondary windings are alternately arranged to surround the primary winding. Two magnetic cores are inserted into the hollow bobbin.

### BRIEF DESCRIPTION OF THE DRAWINGS

FIG. 1 shows a transformer according to one embodiment.

FIG. 2 shows the exploded view of the transformer of FIG. 1.

FIG. 3 shows a circuit diagram of the transformer according to an embodiment.

FIG. 4 shows a flowchart of an assembly method of the transformer.

FIG. 5 shows the detailed structure of the hollow bobbin.

FIG. 6 illustrates step S120 and step S130.

FIGS. 7 to 11 illustrate step S140.

FIG. 12 illustrates step S150 and step S160.

FIG. 13 shows the sectional view of the transformer.

### DETAILED DESCRIPTION

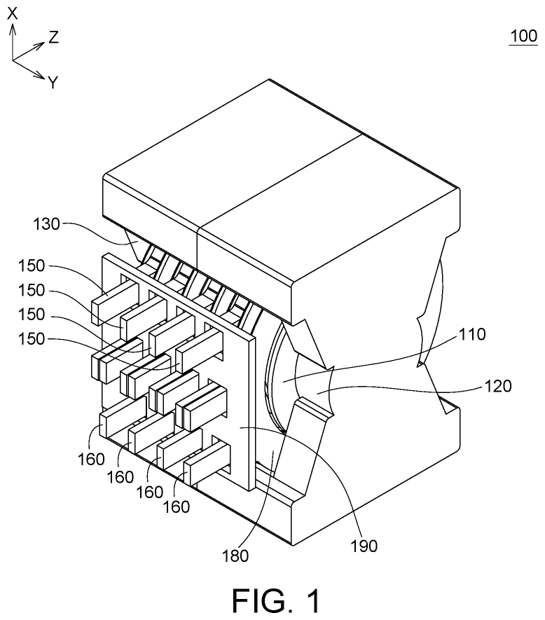

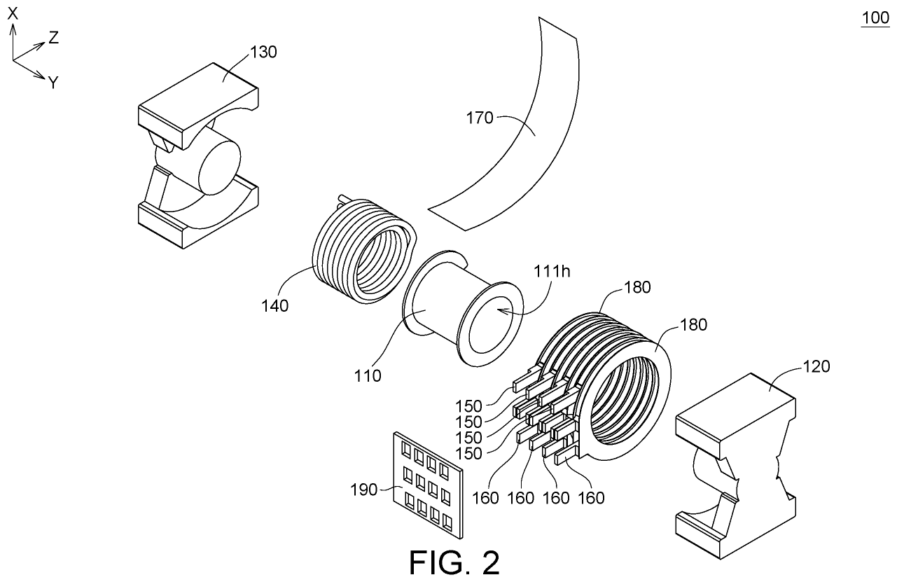

FIG. 1 shows a transformer 100 according to one embodiment. FIG. 2 shows the exploded view of the transformer 100 of FIG. 1. The transformer 100 includes a hollow bobbin 110, two magnetic cores 120, 130, a primary winding 140 (shown in FIG. 2), a plurality of first secondary windings 150, a plurality of second secondary windings 160, an insulating film 170 (shown in FIG. 2) and a plurality of insulating sheets 180. The two magnetic cores 120 and 130 are inserted into the hollow bobbin 110. The primary winding 140 is wound around the hollow bobbin 110. The first secondary windings 150 and the second secondary windings 160 surround the primary winding 140. The first secondary windings 150 and the second secondary windings 160 are alternately arranged around the primary winding 140.

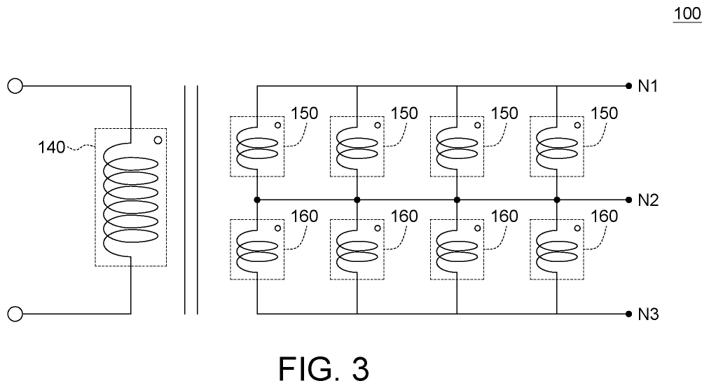

FIG. 3 shows a circuit diagram of the transformer 100 according to an embodiment. The primary winding 140 is connected to an input square wave voltage. Each of the first secondary windings 150 has a first terminal and a second terminal. The first terminal of each of the first secondary windings 150 is connected to a first node N1. The second terminal of each of the first secondary windings 150 is connected to a second node N2. Each of the second secondary windings 160 has a first terminal and a second terminal. The first terminal of each of the second secondary windings 160 is connected to the second node N2. The second terminal of each of the second secondary windings 160 is connected to a third node N3. Thus, in this embodiment, the first secondary windings 150 are connected in parallel. The second secondary windings 160 are connected in parallel.

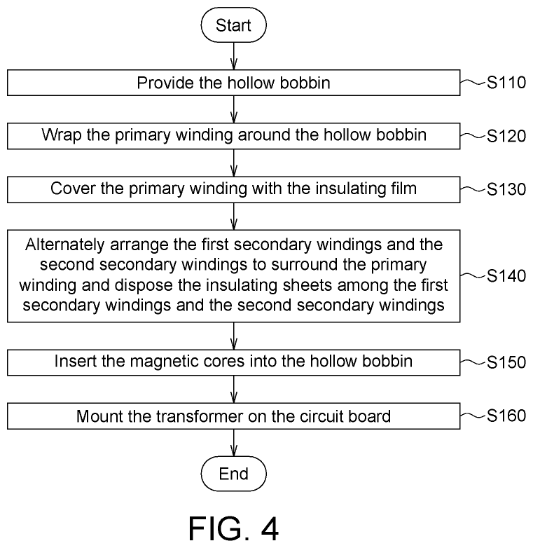

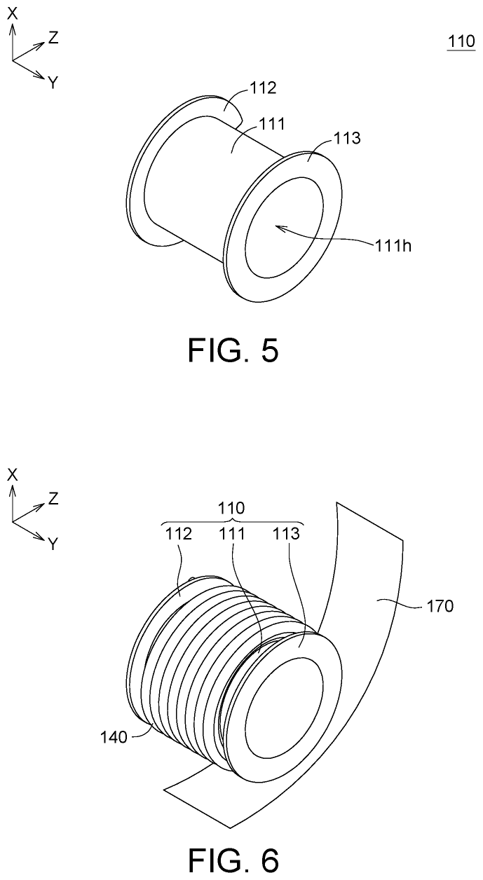

FIG. 4 shows a flowchart of the assembly method of the transformer 100. FIG. 5 shows the detailed structure of the hollow bobbin 110. In step S110, the hollow bobbin 110 is provided. The hollow bobbin 110 is, for example, a hollow cylinder. The hollow bobbin 110 includes a hollow cylinder 111 and two blocking ring sheets 112, 113. The blocking ring sheet 112 and the blocking ring sheet 113 are disposed on opposite sides of the hollow cylinder 111. The hollow bobbin 110 is, for example, made of plastic material. The hollow cylinder 111 has a through hole 111h. Referring to FIG. 2, one side of the through hole 111h is used to insert the magnetic core 120. Another side of the through hole 111h is used to insert the magnetic core 130.

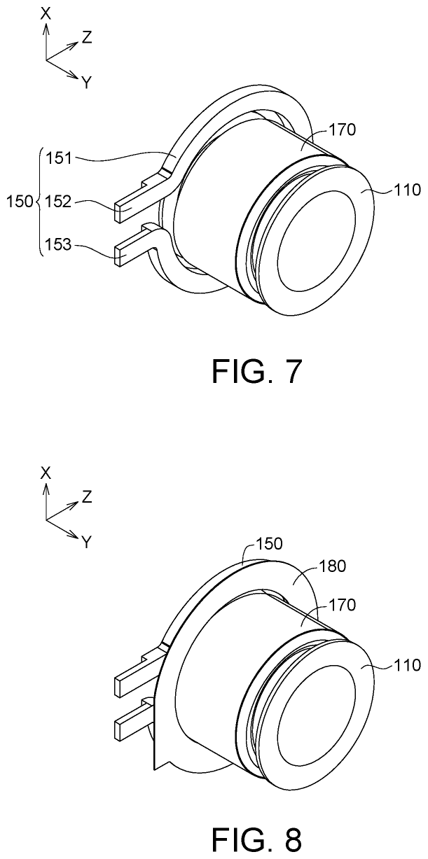

FIG. 6 illustrates step S120 and step S130. In step S120, the primary winding 140 is wrapped around the hollow bobbin 110. The blocking ring sheet 112 and the blocking ring sheet 113 are used to limit the movement of the primary winding 140. The primary winding 140 is, for example, formed of a metal wire. The primary winding 140 has equal wire diameter. For example, the primary winding 140 winds around the hollow bobbin 110 in two layers with 16 turns. The primary winding 140 may have 16 turns in order to step down a DC input voltage from 400V to 12 V.

In step S130, the primary winding 140 is covered with the insulating film 170. The insulating film 170 is, for example, a polyimide tape. The insulating film 170 surrounds the primary winding 140 to avoid short circuit with the first secondary windings 150 and the second secondary windings 160.

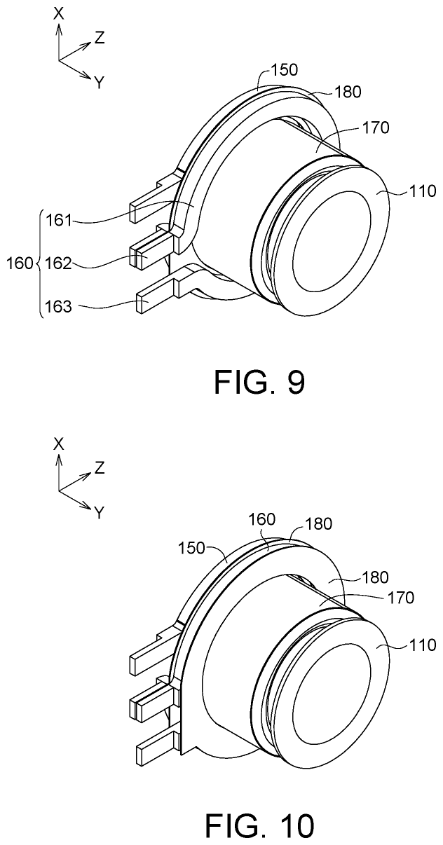

FIGS. 7 to 11 illustrate step S140. In step S140, the first secondary windings 150 and the second secondary windings 160 are alternately arranged to surround the primary winding 140 and the insulating sheets 180 are disposed among the first secondary windings 150 and the second secondary windings 160. Each of the first secondary windings 150 is formed of a metal slot.

Referring to FIG. 7, the first secondary winding 150 is arranged around the primary winding 140. The first secondary winding 150 includes a ring body 151, and two connecting pins 152, 153. The ring body 151 has equal width and thickness. Each of the first secondary windings 150 surrounds the primary winding 140 in one layer. The connecting pins 152, 153 are used to mount on a circuit board 190 (shown in FIG. 1). The first secondary windings 150 mounted on the circuit board 190 will be connected in parallel.

Referring to FIG. 8, in some embodiments, the insulating sheet 180 is disposed beside the first secondary winding 150. The insulating sheet 180 is formed from a polyimide tape. For example, the insulating sheet 180 is ring shaped, and has equal width. The insulating sheet 180 prevents short circuit between each of the first secondary windings 150 and each of the second secondary windings 160.

Referring to FIG. 9, the second secondary winding 160 is arranged around the primary winding 140. Each of the second secondary windings 160 is formed of a metal slot. The second secondary winding 160 includes a ring body 161, and two connecting pins 162, 163. The ring body 161 has equal width and thickness. Each of the second secondary windings 160 surrounds the primary winding 140 in one layer. The connecting pins 162, 163 are used to mount on the circuit board 190. The second secondary windings 160 mounted on the circuit board 190 will be connected in parallel.

Referring to FIG. 10, another insulating sheet 180 is disposed beside the second secondary winding 160. After disposing the insulating sheet 180 beside the second secondary winding 160, the steps illustrated in FIGS. 7 to 10 are repeated. FIG. 11 shows the first secondary windings 150 and the second secondary windings 160 alternately arranged to surround the primary winding 140, and the insulating sheets 180 disposed among the first secondary windings 150 and the second secondary windings 160.

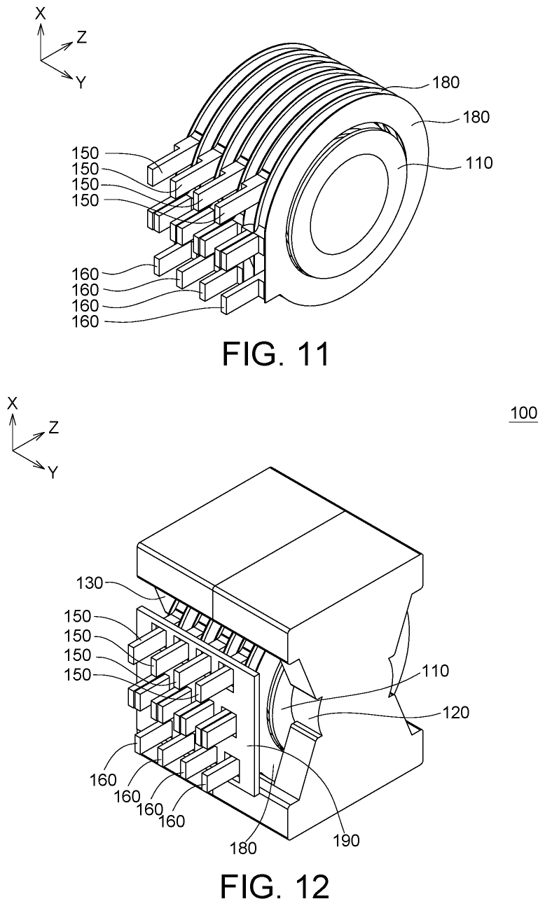

FIG. 12 illustrates step S150 and step S160. In step S150, the two magnetic cores 120 and 130 are inserted into the hollow bobbin 110. The primary winding 140 (not shown in FIG. 12) is wound around the hollow bobbin 110.

In step S160, the transformer 100 is mounted on the circuit board 190. The first secondary windings 150 mounted on the circuit board 190 are connected in parallel. The second secondary windings 160 mounted on the circuit board 190 are connected in parallel.

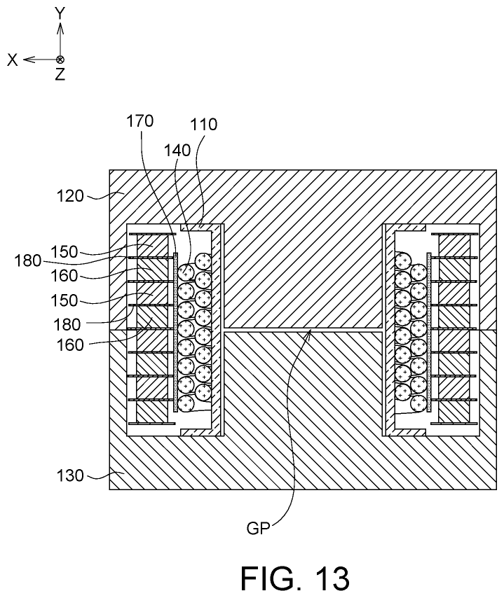

FIG. 13 shows the sectional view of the transformer 100. As shown in FIG. 13, the primary winding 140 is wound around the hollow bobbin 110 in two layers. The first secondary windings 150 and the second secondary windings 160 surround the primary winding 140. The first secondary windings 150 and the second secondary windings 160 are alternately arranged. In other words, one of the first secondary windings 150 is arranged in between any two of the second secondary windings 160. One of the second secondary windings 160 is arranged in between any two of the first secondary windings 150. The cross-sectional areas of the first secondary windings 150 and the second secondary windings 160 are substantially equal. An air gap GP is formed between the two magnetic cores 120 and 130.

Please refer to table I. Compared to the traditional transformer, the ANSYS Maxwell simulated AC to DC resistance ratio (R_{AC}/R_{DC}) of the primary winding 140 of the transformer 100 in the present embodiment at 100 kHz is reduced from 10 to 1.66. The AC to DC resistance ratio (R_{AC}/R_{DC}) of the first secondary windings 150 and the second secondary windings 160 of the transformer 100 in the present embodiment at 100 kHz is reduced from 17.6 to 6.57. Moreover, the primary-to-secondary interwinding capacitance is reduced from 112 pF to 14.3 pF.

TABLE I

| | The traditional | The transformer 100 in |
|---|---|---|
| | transformer | the present embodiment |
| The AC to DC | 10 | 1.66 |
| resistance ratio | | |
| (R_{AC}/R_{DC}) of the | | |
| primary winding | | |
| The AC to DC | 17.6 | 6.57 |
| resistance ratio | | |
| (R_{AC}/R_{DC}) of the | | |
| first secondary | | |
| windings and the second | | |
| secondary windings | | |
| The primary-to-secondary | 112 pF | 14.3 pF |
| interwinding capacitance | | |

Furthermore, please refer to table II for the ANSYS Maxwell simulated losses. Compared to the traditional transformer, the transformer 100 in the present embodiment has much lower secondary winding loss and hence lower overall transformer loss. For example, the primary winding loss at 272A is reduced from 4.33 W to 3.97 W. The secondary winding loss at 272A is reduced from 18.33 W to 6.87 W. The total winding loss at 272A is reduced from 22.66 W to 10.84 W. The total transformer loss at 272A is reduced from 24.76 W to 13.12 W.

TABLE II

| Type of | | | | The transformer 100 in the | | |
|---|---|---|---|---|---|---|
| power | The traditional transformer | | | present embodiment | | |
| loss | 272 A | 200 A | 100 A | 272 A | 200 A | 100 A |
| Primary | 4.33 W | 2.18 W | 0.71 W | 3.97 W | 2.39 W | 1.11 W |
| winding | | | | | | |
| loss | | | | | | |
| Secondary | 18.33 W | 11.98 W | 6.62 W | 6.87 W | 3.91 W | 1.18 W |
| winding | | | | | | |
| loss | | | | | | |
| Total | 22.66 W | 14.16 W | 7.33 W | 10.84 W | 6.3 W | 2.29 W |
| winding | | | | | | |
| loss | | | | | | |
| Average | 2.1 W | 1.79 W | 1.2 W | 2.28 W | 1.96 W | 1.73 W |
| core loss | | | | | | |
| Total | 24.76 W | 15.95 W | 8.53 W | 13.12 W | 8.26 W | 4.02 W |
| transformer | | | | | | |
| loss | | | | | | |

According to the embodiment described above, the AC to DC resistance ratio of the transformer 100 is decreased, and the total power loss of the transformer 100 is reduced. The primary-to-secondary interwinding capacitance of the transformer 100 is reduced, such that EMI is avoided.

It will be apparent to those skilled in the art that various modifications and variations can be made to the disclosed embodiments. It is intended that the specification and examples be considered as exemplary only, with a true scope of the disclosure being indicated by the following claims and their equivalents.

What is claimed is:

1. A transformer, comprising:
a hollow bobbin;
two magnetic cores, inserted into the hollow bobbin;
a primary winding, wound around the hollow bobbin;
a plurality of first secondary windings; and
a plurality of second secondary windings,
wherein the first secondary windings and the second secondary windings surround the primary winding,
wherein the first secondary windings and the second secondary windings are alternately arranged around the primary winding.

2. The transformer according to claim 1, wherein a first terminal of each first secondary winding is connected to a first node, a second terminal of each of the first secondary windings is connected to a second node, a first terminal of each of the second secondary windings is connected to the second node, and a second terminal of each of the second secondary windings is connected to a third node.

3. The transformer according to claim 1, wherein the primary winding is formed of a metal wire, each of the first secondary windings and the second secondary windings is formed of a metal slot.

4. The transformer according to claim 1, wherein an air gap is formed between the two magnetic cores.

5. The transformer according to claim 1, further comprising:
an insulating film, surrounding the primary winding; and
a plurality of insulating sheets, disposed among the first secondary windings and the second secondary windings.

6. The transformer according to claim 1, wherein the primary winding is wound around the hollow bobbin in two layers.

7. The transformer according to claim 1, wherein the primary winding has 16 turns.

8. The transformer according to claim 1, wherein each of the first secondary windings and the second secondary windings surrounds the primary winding in one layer.

9. The transformer according to claim 1, wherein each of the first secondary windings and the second secondary windings surrounds the primary winding in one turn.

10. The transformer according to claim 1, wherein cross-sectional areas of the first secondary windings and the second secondary windings are substantially equal.

11. A transformer, comprising:
a hollow bobbin;
two magnetic cores, inserted into the hollow bobbin;
a primary winding, wound around the hollow bobbin;
a plurality of first secondary windings; and
a plurality of second secondary windings,
wherein the first secondary windings and the second secondary windings surround the primary winding,
wherein an air gap is formed between the two magnetic cores.

12. An assembly method of a transformer, comprising:
wrapping a primary winding around a hollow bobbin;
alternately arranging a plurality of first secondary windings and a plurality of second secondary windings to surround the primary winding; and
inserting two magnetic cores into the hollow bobbin.

13. The assembly method of the transformer according to claim 12, further comprising:
connecting a first terminal of each of the first secondary windings to a first node;
connecting a second terminal of each of the first secondary windings to a second node;
connecting a first terminal of each of the second secondary windings to the second node; and
connecting a second terminal of each of the second secondary windings to a third node.

14. The assembly method of the transformer according to claim 12, wherein the primary winding is formed of a metal wire, each of the first secondary windings and the second secondary windings is formed of a metal slot.

15. The assembly method of the transformer according to claim 12, wherein an air gap is formed between the two magnetic cores.

16. The assembly method of the transformer according to claim 12, further comprising:
covering the primary winding with an insulating film; and
disposing a plurality of insulating sheets among the first secondary windings and the second secondary windings.

17. The assembly method of the transformer according to claim 12, wherein the primary winding is wrapped around the hollow bobbin in two layers.

18. The assembly method of the transformer according to claim 12, wherein the primary winding is wrapped around the hollow bobbin in 16 turns.

19. The assembly method of the transformer according to claim 12, wherein each of the first secondary windings and the second secondary windings surrounds the primary winding in one layer.

20. The assembly method of the transformer according to claim 12, wherein cross-sectional areas of the first secondary windings and the second secondary windings are substantially equal.
